(19) United States
(12) Patent Application Publication
(10) Pub. No.: US 2003/0182399 A1
(43) Pub. Date: Sep. 25, 2003

(54) Method and apparatus for monitoring web access

(76) Inventor: Matthew A. Silber, Hillsboro, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/104,702

(22) Filed: Mar. 21, 2002

(51) Int. Cl. G06F 15/16; G06F 9/46

(52) U.S. Cl. 709/219; 709/218; 709/318

(57) ABSTRACT

Web access monitoring is accomplished by obtaining a plurality of graphical output images output by a processing system during use by a first user, processing the images into a video file, and a second user viewing the video file. Background data corresponding to each graphical image, such as the Uniform Resource Locator (URL) of a Web page being viewed and the time, is obtained and integrated into the video file. A timer determines the frequency at which the graphical images are obtained. Also, the time at which the graphical images are obtained is determined by trigger events, such as a new Web page being loaded.

### BACKGROUND

1. Field

The present invention relates generally to Web access monitoring and, more specifically, to capturing and compiling screen shot images into an easily viewable video.

2. Description

The Web and widely available processing systems, such as desktop computers, laptop computers, and Personal Digital Assistants (PDA)s are making an abundance of content easily accessible to more people in more locations than in previous years. In some instances, one may wish to restrict or monitor access to some of the content available on the World Wide Web (WWW). For instance, not all content is appropriate for viewers of all ages. Children often access content on the Web for school projects or for pursuing personal interests. It may also be desirable to restrict or monitor access to content on the Web on public processing systems, such as those in libraries or schools.

A few methods currently exist to restrict access to content available on the Web. One method is to use Uniform Resource Locator (URL)-list blocking filters. With URL-list blocking, a list of Web sites to which access is to be restricted is kept. When a user tries to access a Web page, the Web page's URL is checked against the list of restricted Web pages' URLs. If the Web page's URL is on the list, the user is not allowed to access the Web page. This method works adequately when the URLs of Web pages to be blocked are static. However, a major problem with this method is that the URLs of many Web sites are changed often. Also, more Web sites are made available on the Web all the time, making it nearly impossible to keep an accurate, up-to-date list of URLs to be blocked.

A second method to restrict access to content available on the Web is to use word-matching filters. With word-matching filters, each Web page that the user tries to load is scanned to determine whether it contains one or more words from a set of predetermined words that are considered inappropriate. If a Web page contains one or more of these words, access to the Web page is restricted. However, a major problem with this method is that the context in which words are used is not taken into consideration. This almost invariably causes many Web pages considered appropriate to be unintentionally blocked.

Because of the limitations in trying to restrict access to content on the Web, Web access restriction is often used in conjunction with Web access monitoring. An advantage of Web access monitoring over Web access restriction is that it uses human judgment to determine what constitutes inappropriate content.

Web access monitoring is typically accomplished by a processing system keeping logs of the Web sites a user visits. These access logs are then viewed by a parent or system administrator to determine whether any inappropriate content was accessed. However, a problem with this method is that the text of a URL is often not representative of the content of the Web page it points to. It can therefore be difficult to determine from a log of URLs alone whether inappropriate content has been accessed.

What is needed is a method and apparatus for monitoring Web access that can be used as a complement to access restrictions, and that addresses the disadvantages of current Web access monitoring technologies.

### BRIEF DESCRIPTION OF THE DRAWINGS

The features and advantages of the present invention will become apparent from the following detailed description of the present invention in which:

FIG. 1 is a flow diagram illustrating concatenation of screen capture images into a video file according to an embodiment of the present invention;

FIG. 2 is a diagram of an apparatus for monitoring Web access according to an embodiment of the present invention; and

FIG. 3 is a flow diagram illustrating screen capture content collection and video file creation processing according to an embodiment of the present invention.

### DETAILED DESCRIPTION

An embodiment of the present invention comprises a method and apparatus for monitoring Web access.

Reference in the specification to “one embodiment” or “an embodiment” of the present invention means that a particular feature, structure or characteristic described in connection with the embodiment is included in at least one embodiment of the present invention. Thus, the appearances of the phrase “in one embodiment” appearing in various places throughout the specification are not necessarily all referring to the same embodiment.

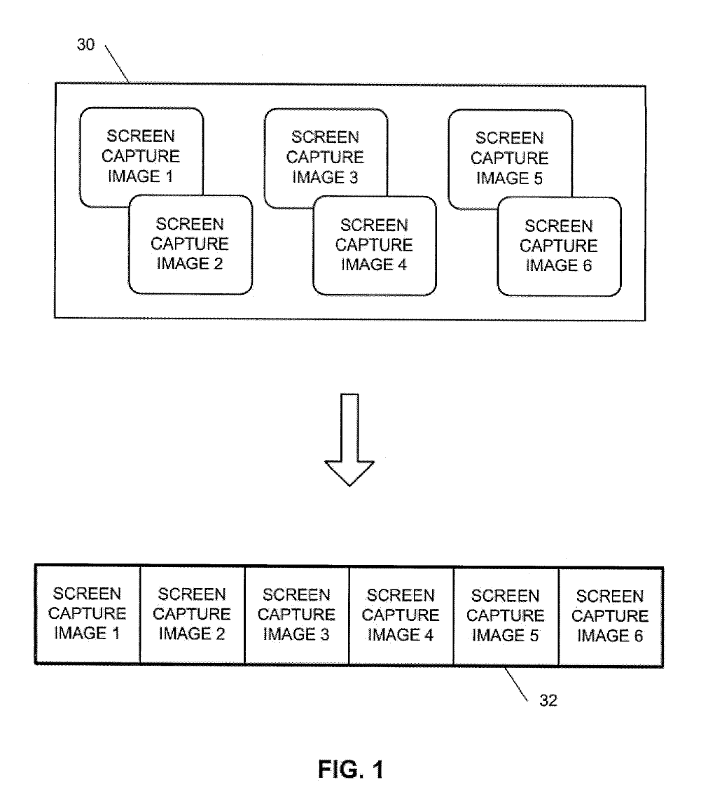

FIG. 1 is a flow diagram illustrating concatenation of screen capture images 30 into a video file 32 according to an embodiment of the present invention. A screen capture image is an image that represents a portion, or the entirety, of a processing system's output screen at a particular point in time. Processing systems include, for example, desktop computers, laptop computers, and Personal Digital Assistants (PDA)s. The one or more screen capture images are obtained over a period of time and stored by the processing system in a memory 58. When a predetermined time period has elapsed, the one or more screen capture images may be concatenated by the processing system into a video file. This results in a video file with a chronological composite of the screen capture images. One can view the video file to more easily monitor the Web access that occurred over the time period.

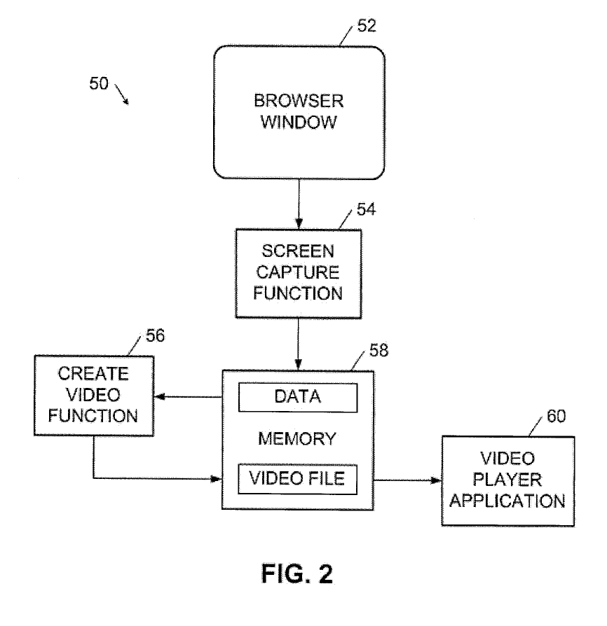

FIG. 2 is a diagram of an apparatus for monitoring Web access according to an embodiment of the present invention. In one embodiment, the processing system 50 includes a browser program with a browser window 52 that displays Web pages containing pictures, text, and multimedia content, as well other content available on a network such as the Web.

Screen capture function 54 obtains screen capture content at discrete points in time, over a time period, that correspond to some or all of the content being displayed in the browser window 52. In one embodiment, the screen capture content includes a screen capture image corresponding to a graphical image of the Web browser's output window. The screen capture content also may include background data related to the graphical content displayed by the browser window. The background data might include the Uniform Resource Locator (URL) of the Web page currently being viewed, the time, the date, or a list of names of users engaged in a chat session with the processing system's current user. In another embodiment, the screen capture function could obtain screen capture content related to the use of a program other than a browser, such as a video game. In yet another embodiment, the screen capture function could obtain screen capture content corresponding to the entirety of an output display screen of the processing system.

The time at which the screen capture function obtains screen capture content during a given monitoring period can be controlled by multiple criteria. For instance, a frequency can be set by a supervising user that specifies how often screen capture content is to be obtained. Also, various events can act as trigger mechanisms for the screen capture function to obtain screen capture content. Such trigger events might include information being requested by the browser program using a new URL, a Web page being refreshed, a background window being brought to the foreground of the display screen, or the user initiating execution of a program.

One or more of multiple well-known methods may be used by the screen capture function 54 to obtain screen capture images. For instance, screen capture images may be obtained from a video frame buffer using graphics card drivers. Screen capture images may also be obtained by using Operating System (OS) extensions, by querying a browser program directly, or by using a plug-in software component to the Web browser program. To obtain background data on the information currently being displayed in the browser window 52, a plug-in software component to the browser program could be used.

In one embodiment, the screen capture images and background data obtained by the screen capture function may be stored by the processing system in a memory 58 in the form of multiple data files. The screen capture images may be stored in a well-known image-encoding format such as the Bit-Mapped (BMP) image format or the Joint Photographic Experts Group (JPEG) format. When the monitoring time period has elapsed, the multiple data files may be processed by create video function 56 into a video file, which is stored by the processing system 50 in memory. The video file could be stored in a popular format such as the Moving Picture Experts Group (MPEG) format, the Audio Video Interleave (AVI) format, or the Quicktime™ format. The background data, in one embodiment, might be incorporated in the video file by designating a section of the video for displaying the background data for each screen capture image.

In another embodiment, the create video function 56 could process the data representing the screen capture content into a video file in real-time, during the monitoring period, rather than after the monitoring period is over.

A commonly available video player application 60 can be used to review, or play, the video file for monitoring purposes, for example, the Windows Media Player™ from Microsoft Corporation or the QuickTime™ media player from Apple Computer, Inc.

The rate at which individual screen capture images are displayed to the supervising user while the video file is being rendered can be manipulated either before video file creation or after video file creation. The rate can be manipulated before video file creation by varying the number of frames used in creation of the video file. For example, to display one image file per second, using a 30 frames per second (fps) playback rate for MPEG files, 30 copies of each image file could be placed consecutively in sequence in the video file. Alternatively, many video player applications enable the user to adjust the fps playback of a video during playback. In this embodiment, the create video function may create a video file to display one screen shot image per second. The video player application could then be used to adjust the playback rate as needed.

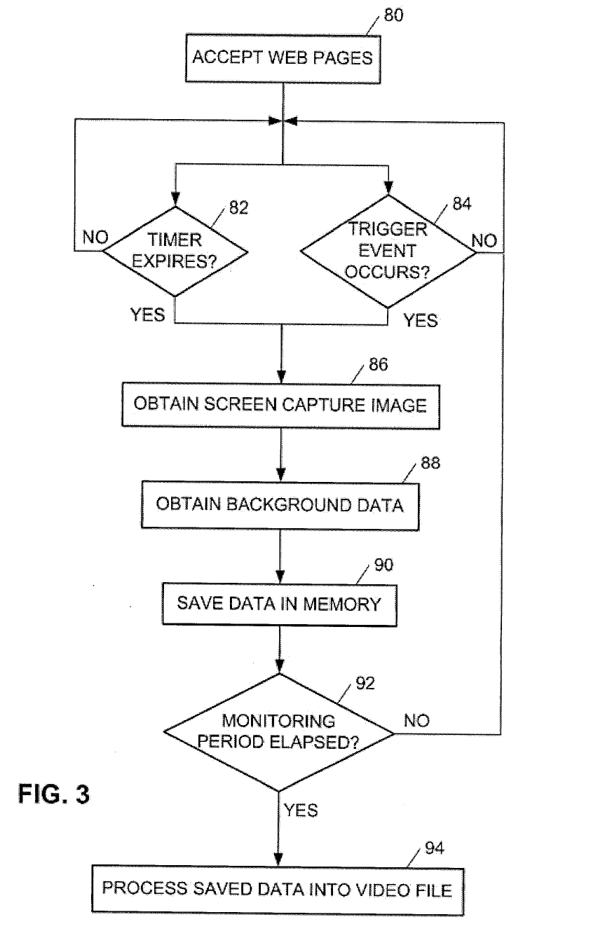

FIG. 3 is a flow diagram illustrating screen capture content collection and video file creation processing according to an embodiment of the present invention. A Web browser, executing on a processing system, accepts Web pages 80 and displays the Web pages in the Web browser window 52. A timer may be used to keep track of the frequency with which screen capture content is to be obtained. Also, as previously discussed, various events can act as triggers to cause screen capture content to be obtained. Therefore, if either the timer expires 82, or a trigger event occurs 84, the screen capture function obtains both a screen capture image 86 and background data 88. Otherwise, the processing system continues checking whether the timer has expired or a trigger event has occurred.

In one embodiment, after the screen capture image and information about the browser's current state are collected by the screen capture function, the processing system saves the data in memory 90.

In one embodiment, if the monitoring period has not elapsed 92, the processing system continues checking whether the timer has expired or a trigger event has occurred. If the monitoring period has expired, the saved data is processed into a video file 94.

A commonly available video player application 60 can be used to review, or play, the video file.

The techniques described herein are not limited to any particular hardware or software configuration; they may find applicability in any computing or processing environment. The techniques may be implemented in hardware, software, or a combination of the two. The techniques may be implemented in programs executing on programmable machines such as mobile or stationary computers, personal digital assistants, set top boxes, cellular telephones and pagers, and other electronic devices, that each include a processor, a storage medium readable by the processor (including volatile and non-volatile memory and/or storage elements), at least one input device, and one or more output devices. Program code is applied to the data entered using the input device to perform the functions described and to generate output information. The output information may be applied to one or more output devices. One of ordinary skill in the art may appreciate that the invention can be practiced with various computer system configurations, including multiprocessor systems, minicomputers, mainframe computers, and the like. The invention can also be practiced in distributed computing environments where tasks may be performed by remote processing devices that are linked through a communications network.

Each program may be implemented in a high level procedural or object oriented programming language to communicate with a processing system. However, programs may be implemented in assembly or machine language, if desired. In any case, the language may be compiled or interpreted.

Program instructions may be used to cause a general-purpose or special-purpose processing system that is programmed with the instructions to perform the operations described herein. Alternatively, the operations may be performed by specific hardware components that contain hardwired logic for performing the operations, or by any combination of programmed computer components and custom hardware components. The methods described herein may be provided as a computer program product that may include a machine readable medium having stored thereon instructions that may be used to program a processing system or other electronic device to perform the methods. The term “machine readable medium” used herein shall include any medium that is capable of storing or encoding a sequence of instructions for execution by the machine and that cause the machine to perform any one of the methods described herein. The term “machine readable medium” shall accordingly include, but not be limited to, solid-state memories, optical and magnetic disks, and a carrier wave that encodes a data signal. Furthermore, it is common in the art to speak of software, in one form or another (e.g., program, procedure, process, application, module, logic, and so on) as taking an action or causing a result. Such expressions are merely a shorthand way of stating the execution of the software by a processing system cause the processor to perform an action of produce a result.

While this invention has been described with reference to illustrative embodiments, this description is not intended to be construed in a limiting sense. Various modifications of the illustrative embodiments, as well as other embodiments of the invention, which are apparent to persons skilled in the art to which the invention pertains are deemed to lie within the spirit and scope of the invention.

What is claimed is:

1. A method of monitoring access to content comprising:
capturing a plurality of graphical images output by a processing system during use by a first user;
processing the plurality of graphical images into a video file; and
making the video file available for a second user to monitor the graphical images.

2. The method of claim 1, wherein the graphical images comprise content from a Web browser's output window.

3. The method of claim 2, further comprising using a plug-in software component to capture the graphical images from the Web browser's output window.

4. The method of claim 2, further comprising obtaining background data corresponding to each captured graphical image, wherein the background data includes at least one of the Uniform Resource Locator (URL) of the Web page associated with the graphical image, the time the Web page was accessed, and the date the Web page was accessed.

5. The method of claim 4, further comprising using a plug-in software component to obtain the background data corresponding to the graphical images of the Web browser's output window.

6. The method of claim 1, wherein each graphical image corresponds to the entirety of an output display screen of the processing system.

7. The method of claim 1, further comprising obtaining the graphical images output by the processing system from a video frame buffer.

8. The method of claim 1, further comprising obtaining background data corresponding to each captured graphical image, wherein the background data includes a list of names of users engaged in a chat session with the first user.

9. The method of claim 1, further comprising using a timer to determine the time at which a graphical image is obtained.

10. The method of claim 1, further comprising using trigger events to determine the time at which a graphical image is obtained.

11. The method of claim 1, further comprising storing the graphical images in memory in Joint Photographic Experts Group (JPEG) format.

12. The method of claim 1, further comprising encoding the video file in Moving Pictures Experts Group (MPEG) format.

13. The method of claim 1, further comprising processing the graphical images into a video file in real time, as the images are captured.

14. The method of claim 1, further comprising processing the graphical images into a video file upon completion of a monitoring period.

15. The method of claim 1, further comprising determining the number of images displayed per second in the video file when processing the plurality of graphical images into the video file.

16. The method of claim 1, further comprising storing the video file to a non-volatile storage.

17. An article of manufacture comprising:
a machine-accessible medium having associated data, wherein the data, when accessed, results in a machine performing:
capturing a plurality of graphical images output by a processing system during use by a first user;
processing the plurality of graphical images into a video file; and making the video file available for a second user to monitor the graphical images.

18. The article of manufacture of claim 17, wherein the graphical images comprise content from a Web browser's output window.

19. The article of manufacture of claim 18, wherein accessing the data further results in the machine performing:
using a plug-in software component to capture the graphical images from the Web browser's output window.

20. The article of manufacture of claim 18, wherein accessing the data further results in the machine performing:
obtaining background data corresponding to each captured graphical image, wherein the background data includes at least one of the Uniform Resource Locator (URL) of the Web page associated with the graphical image, the time the Web page was accessed, and the date the Web page was accessed.

21. The article of manufacture of claim 18, wherein accessing the data further results in the machine performing:
using a plug-in software component to obtain the background data corresponding to the graphical images of the Web browser's output window.

22. The article of manufacture of claim 17, wherein each graphical image corresponds to the entirety of an output display screen of the processing system.

23. The article of manufacture of claim 17, wherein accessing the data further results in the machine performing:
obtaining the graphical images output by the processing system from a video frame buffer.

24. The article of manufacture of claim 17, wherein accessing the data further results in the machine performing:
obtaining background data corresponding to each captured graphical image, wherein the background data includes a list of names of users engaged in a chat session with the first user.

25. The article of manufacture of claim 17, wherein accessing the data further results in the machine performing:
using a timer to determine the time at which a graphical image is obtained.

26. The article of manufacture of claim 17, wherein accessing the data further results in the machine performing:
using trigger events to determine the time at which a graphical image is obtained.

27. The article of manufacture of claim 17, wherein accessing the data further results in the machine performing:
storing the graphical images in memory in Joint Photographic Experts Group (JPEG) format.

28. The article of manufacture of claim 17, wherein accessing the data further results in the machine performing:
encoding the video file in Moving Pictures Experts Group (MPEG) format.

29. The article of manufacture of claim 17, wherein accessing the data further results in the machine performing:
processing the graphical images into a video file in real time, as the images are captured.

30. The article of manufacture of claim 17, wherein accessing the data further results in the machine performing:
processing the graphical images into a video file upon completion of a monitoring period.

31. The article of manufacture of claim 17, wherein accessing the data further results in the machine performing:
determining the number of images displayed per second in the video file when processing the plurality of graphical images into the video file.

32. The article of manufacture of claim 17, wherein accessing the data further results in the machine performing:
storing the video file to a non-volatile storage.

33. An apparatus for monitoring access to content comprising:
a first component to obtain a plurality of graphical images displayed by a processing system; and
a second component to create a video file from the plurality of graphical images.

34. The apparatus of claim 33, further comprising a third component to play the video file.

35. The apparatus of claim 33, further comprising a browser component to generate the plurality of graphical images.

36. The apparatus of claim 35, further comprising a plug-in component to obtain background data corresponding to each captured graphical image, wherein the background data includes at least one of the Uniform Resource Locator (URL) of the Web page associated with the graphical image, the time the Web page was accessed, and the date the Web page was accessed.

37. The apparatus of claim 33, further comprising a timer component to keep track of the frequency at which graphical images are to be obtained.

38. The apparatus of claim 33, further comprising a component to detect a trigger event in the processing system and cause a graphical image to be obtained.
